(19) United States
(12) Patent Application Publication
(10) Pub. No.: US 2008/0058146 A1
(43) Pub. Date: Mar. 6, 2008

(54) System and method of controlling a pump system having a clutch and planetary gear assembly

(76) Inventors: William P. Pizzichil, Easley, SC (US); Chuong Huy Nguyen, Simpsonville, SC (US); William C. Livoti, Simpsonville, SC (US)

Correspondence Address: THOMPSON COBURN, LLP, ONE US BANK PLAZA, SUITE 3500, ST LOUIS, MO, 63101, US

(21) Appl. No.: 11/513,778

(22) Filed: Aug. 31, 2006

(51) Int. Cl. F16H 47/04

(52) U.S. Cl. 475/72

(57) ABSTRACT

In certain embodiments, a pump system includes a variable output transmission having a rotatable motor coupling, a rotatable pump coupling, a planetary gear assembly disposed between the rotatable motor coupling and the rotatable pump coupling, and a clutch disposed between the rotatable motor coupling and the rotatable pump coupling. The pump system also includes a controller configured to control the clutch in response to fluid pumping feedback.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Pumps may be used in a wide variety of applications to transfer a liquid, such as water, from one location to another. For example, one or more pumps may transfer a large quantity of water from a lake, cooling pond, river, or ocean to a remote facility or site. In certain applications, the one or more pumps may transfer the liquid, e.g., water, horizontally for miles to reach the remote facility or site.

Unfortunately, the start up and shut down stages may adversely affect the pump and associated components due to transient hydraulic instabilities. The hydraulic instabilities associated with the start up and shut down stages generally increase with greater vertical and horizontal distances between the pump and the remote site. Unfortunately, the transient hydraulic instabilities generally reduce the life of the pump and associated components. For example, an abrupt change in the flow or pressure within the pumping system can result in water hammer, which may cause piping failures, broken pump shafts, motor damage, structural damage, broken pipe hangers, mechanical seal failures, and so forth.

In addition, the pumps and motors in certain pumping systems may be very large and expensive due to various operational parameters. For example, in high-flow, low-head, vertical pumping systems, the desired speed of the pump may be significantly below the nominal speed of a typical two or four pole motor. Unfortunately, the motor cost, size and weight generally increase dramatically with corresponding increases in the horse power ratings, e.g., greater than one thousand horse power. In turn, the increased size and weight of the motor generally results in a larger pump and support structure.

### BRIEF DESCRIPTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In certain embodiments, a pump system includes a variable output transmission having a rotatable motor coupling, a rotatable pump coupling, a planetary gear assembly disposed between the rotatable motor coupling and the rotatable pump coupling, and a clutch disposed between the rotatable motor coupling and the rotatable pump coupling. The pump system also includes a controller configured to control the clutch in response to fluid pumping feedback.

### DRAWINGS

These and other features, aspects, and advantages of the present technique will become better understood when the following detailed description is read with reference to the accompanying drawings in which like characters represent like parts throughout the drawings, wherein:

FIG. 1 is a block diagram illustrating an embodiment of a liquid transfer or pumping system having a planetary gear system coupled to a motor and a pump;

FIG. 2 is a block diagram of an embodiment of a modular pumping system having a planetary gear system;

FIG. 3 is a block diagram of an embodiment of a modular drive system;

FIG. 4 is a block diagram of an embodiment of a modular pump system;

FIG. 5 is a perspective view of an embodiment of a vertical pump drive having a motor coupled to an integral planetary gear and clutch module;

FIG. 6 is an exploded perspective view of an embodiment of the vertical pump drive as illustrated in FIG. 5;

FIG. 7 is an exploded perspective view of an embodiment of the integral planetary gear and clutch module as illustrated in FIGS. 5 and 6;

FIG. 8 is a cross-sectional view of an embodiment of the integral planetary gear and clutch module as illustrated in FIGS. 5-7;

FIG. 9 is a cross-sectional view of an embodiment of a planetary or epicyclic gear assembly disposed within the integral planetary gear and clutch module as illustrated in FIGS. 5-8; and

FIG. 10 is a flow chart of an embodiment of a start up process for the vertical pump drive as illustrated in FIGS. 5-9.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

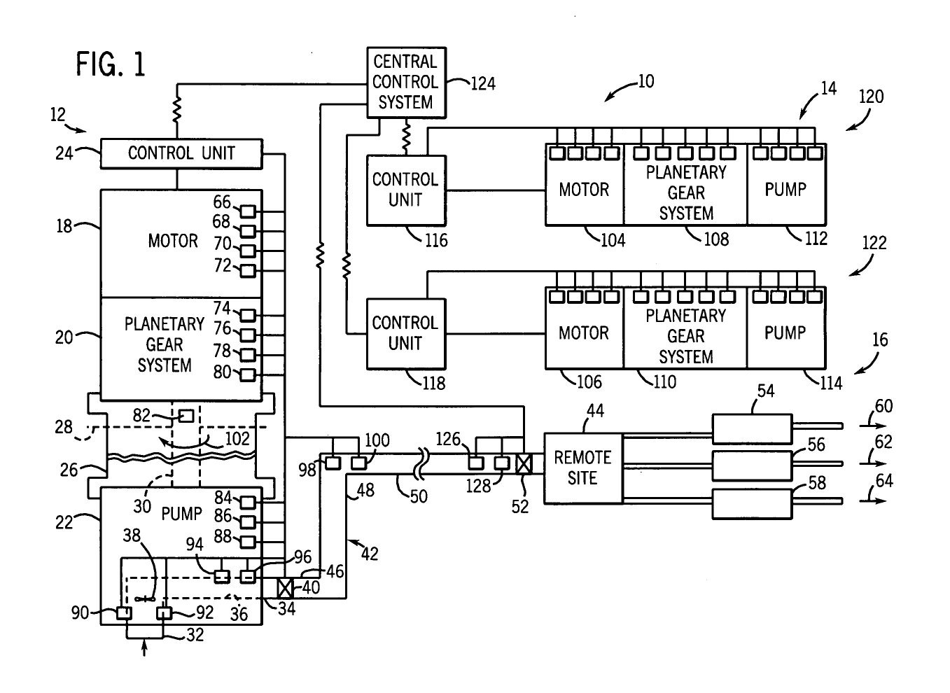

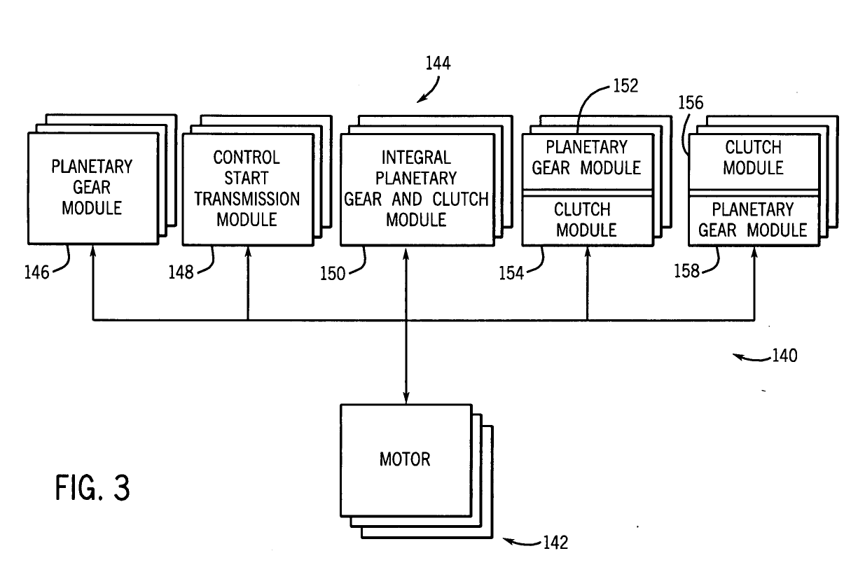

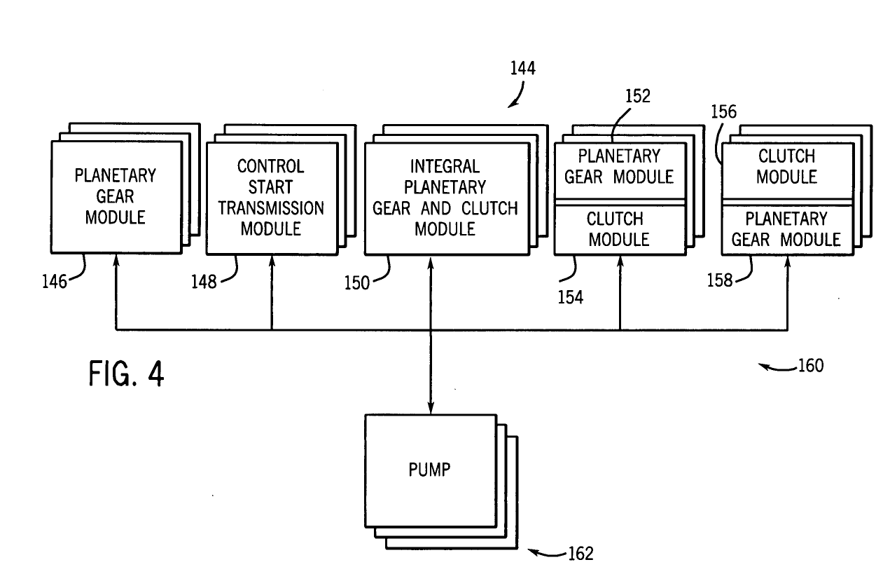

FIG. 1 is a block diagram of an embodiment of a liquid transfer or pumping system 10 having one or more planetary gear systems disposed between respective motors and pumps. In the following discussion, the planetary gear system is used simply for convenience, and is intended to cover either a planetary gear system (e.g., 146) or a planetary gear system with a clutch or a brake mechanism (e.g., 150). In certain modular systems as discussed below with reference to FIGS. 3 and 4, various transmissions and/or clutch systems including 146 and 148 may be exchanged with one another based on the specific parameters of the pumping application. In the embodiments as discussed below with reference to FIGS. 1, 2, and 5-10, each of the planetary gear systems generally includes a planetary gear assembly, which also may include a clutch or brake assembly to vary (e.g., increase or decrease) the output from the motor to the respective pump. However, in other embodiments, such as illustrated in FIGS. 3 and 4, a control start transmission module 148 may be used with or without a planetary gear assembly.

As illustrated in FIG. 1, the liquid transfer or pumping system 10 may include a first or vertical pump arrangement 12, a second or horizontal pump arrangement 14, and a third or horizontal pump arrangement 16. In certain embodiments, the first or vertical pump arrangement 12 includes a motor 18, a planetary gear system 20 coupled to the motor 18, a pump 22 coupled to the planetary gear system 20, and a control unit 24 communicatively coupled to one or more of the vertically arranged components 18, 20, and 22. For example, the control unit 24 may include a pump speed and/or thrust controller to vary the pumping speed and, thus, thrust based on various conditions in the liquid transfer or pumping system 10.

As discussed in further detail below, embodiments of the planetary gear system 10 enable use of significantly smaller sized motors and support structures, thereby reducing costs and complexities of the pumping system 10. For example, the planetary gear system 20 enables a substantial reduction in the dimensions, weight, and general size of the motor 18 to drive the pump 22. In turn, the smaller size of the motor 18 enables a reduction in the dimensions, weight, and general size of a support structure 26, which may be configured to support the motor 18, the planetary gear system 20, and the pump 22.

In addition, embodiments of the planetary gear system 20 enable a generally smooth and gradual transition during start up, shut down, or other stages or periods involving hydraulic instabilities. In other words, the planetary gear system 20 may gradually change (e.g., increase or decrease) the speed of the pump 22 during transient stages (e.g., startup or shutdown), thereby reducing the possibility of water hammer and other undesirable abrupt changes in the pumping system 10. For example, a clutch mechanism (e.g., a wet clutch) of the planetary gear system 20 may be controlled to vary a degree of slip between clutch plates, thereby varying the output speed to the pump 22. In this manner, the planetary gear system 20 can gradually change the pump speed based on various input/sensed parameters.

In the illustrated embodiment, the pump 22 is submerged in water below a water line 28, while the motor 18, the planetary gear system 20, and the control unit 24 are disposed above the water line 28. In addition, the illustrated planetary gear system 20 is coupled to the pump 22 by a shaft 30. In other embodiments, the motor 18, the planetary gear system 20, and the pump 22 may be coupled directly together and mounted above the water line 28, while an intake conduit extends to a point below the water line 28. However, in the illustrated embodiment, the pump 22 includes one or more fluid inlets 32 and one or more fluid outlets 34 submerged below the water line 28 along with the rest of the pump 22.

Although the pump 22 may include a variety of pumping features, the illustrated pump 22 includes one or more fluid passages 36 having one or more pump impellers 38 disposed between the fluid inlet 32 and the fluid outlet 34. The pump 22 also can include one or more check valves, manual valves, or electromechanical valves. For example, the check valves generally reduce or prevent flow of fluid from the fluid outlet 34 back through the fluid passages 36 to the fluid inlet 32. The electromechanical valves also can be controlled via the control unit 24. In the illustrated embodiment, an electromechanical valve 40 is coupled to the pump 22 at or near the fluid outlet 34.

In addition, a water or fluid conduit 42 is coupled to the electromechanical valve 40 and extends both vertically and horizontally to a remote site 44. For example, the illustrated fluid conduit 42 includes a relatively short horizontal conduit portion 46, a vertical conduit portion 48, and a relatively long horizontal conduit portion 50. In some embodiments, the vertical conduit portion 48 may have a relatively short length, height, or head between the horizontal conduit portions 46 and 50, while the long horizontal conduit portion 50 may extend for miles to the remote site 44. At the remote site 44, another electromechanical valve 52 may be coupled to the fluid conduit 42. The remote site 44 also can include one or more fluid delivery or distribution systems, such as systems 54, 56, and 58. These systems 54, 56, and 58 each can include a motor, a planetary gear system (with or without a clutch or brake mechanism), and a pump to transport the water or fluid to another downstream location as indicated by arrows 60, 62, and 64.

In the illustrated embodiment of FIG. 1, the control unit 24 is communicatively coupled to a plurality of sensors disposed in the first or vertical pump arrangement 12 and along the water or fluid conduit 42 to the remote site 44. For example, the illustrated control unit 44 is communicatively coupled to sensors 66, 68, 70, and 72 disposed on, within, or in proximity to the motor 18. In addition, the illustrated control unit 24 is communicatively coupled to sensors 74, 76, 78, and 80 disposed on, within, or in general proximity to the planetary gear system 20. The control unit 24 also may be coupled to one or more sensors 82 disposed on or adjacent the shaft 30 extending between the planetary gear system 20 and the pump 22. Furthermore, the illustrated control unit 24 is communicatively coupled to sensors 84, 86, 88, 90, 92, 94, and 96 disposed on, within, or in proximity to various portions of the pump 22. For example, the sensors 90, 92, 94, and 96 may be disposed outside or at least partially or entirely within the one or more fluid passages 36 of the pump 22. In addition, the illustrated control unit 24 can be coupled to one or more sensors 98 and 100 disposed outside or at least partially inside or within the fluid conduit 42, such as at a top portion of the vertical conduit portion 48.

In general, the sensors 66-100 may include temperature sensors, pressure sensors, voltage sensors, current sensors, torque sensors, mechanical speed sensors (e.g., linear or rotational speed), fluid speed sensors, fluid mass or volumetric flow rate sensors, and so forth. These sensors 66-100 generally provide feedback to the control unit 24, which can then respond in a closed loop to adjust characteristics of the motor 18, the planetary gear system 20, and/or the pump 22. For example, as discussed in detail below, the feedback from the sensors 66-100 may trigger the control unit 24 to increase or decrease the speed of the motor 18. The feedback from the sensors 66-100 also may trigger the control unit 24 to increase or decrease the engagement of a clutch (e.g., a wet clutch) disposed within the planetary gear system 20, thereby selectively increasing or decreasing an output rate of rotation 102 of the shaft 30. In turn, the feedback controlled rate of rotation 102 alters the general speed or flow rate of the pump 22. In certain embodiments, this feedback control of the motor 18, the planetary gear system 20, and the pump 22 enables a more gradual start up or shut down of the vertical pump arrangement 12, thereby substantially reducing the possibility of abrupt hydraulic changes or damage in the liquid transfer or pumping system 10. The feedback control may continue until the liquid transfer or pumping system 10 reaches a hydraulically stable condition between the pump 22 and the remote site 44, for example. The feedback control also may continue after reaching a hydraulically stable condition, thereby providing a response mechanism for any changes in the system 10.

Similar to the first or vertical pump arrangement 12, the second and third horizontal pump arrangement 14 and 16 as illustrated in FIG. 1 include motors 104 and 106, planetary gear systems 108 and 110 coupled to the respective motors 104 and 106, and pumps 112 and 114 coupled to the respective planetary gear systems 108 and 110. In addition, the illustrated horizontal pump arrangements 14 and 16 include control units 116 and 118 communicatively coupled to the components. For example, the control unit 116 is communicatively coupled to a plurality of sensors 120 disposed on, within, or in general proximity to the motor 104, the planetary gear system 108, and the pump 112. Similarly, the illustrated control unit 118 is communicatively coupled to a plurality of sensors 122 disposed on, within, or in general proximity to the motor 106, the planetary gear system 110, and the pump 114. These sensors 120 and 122 can include a variety of sensors, such as those described above with reference to sensors 66-100. In the illustrated embodiment of FIG. 1, the second and third horizontal pump arrangement 14 and 16 include the pumps 112 and 114 coupled to the respective planetary gear systems 108 and 110. In alternative embodiments, the arrangements 14 and 16 may include other loads or machinery, such as conveyer belts, coupled to the planetary gear systems 108 and 110 and the corresponding motors 104 and 106.

In addition, the illustrated liquid transfer or pump system 10 can include a central control system 124 communicatively coupled to one or more of the pump arrangements 12, 14, and 16 and the remote site 44. The central control system 124 also may be communicatively coupled to one or more sensors disposed throughout the overall liquid transfer or pumping system 10. For example, the illustrated central control system 124 is communicatively coupled to the electromechanical valve 52 and additional sensors 126 and 128 disposed along the water or fluid conduit 42 at or near the remote site 44. In operation, the central control system 124 can transmit, receive, and generally exchange sensed feedback, data, and commands with the control units 24, 116, and 118 associated with the first or vertical pump arrangement 12, the second or horizontal pump arrangement 14, and the third or horizontal pump arrangement 16 as well as the remote site 44. Again, various feedback may be employed by the central control system 124 and the various control units 24, 116, and 118 to alter the operational characteristics of the motors 18, 104, and 106, the corresponding planetary gear systems 20, 108, and 110, and the corresponding pumps 22, 112, and 114.

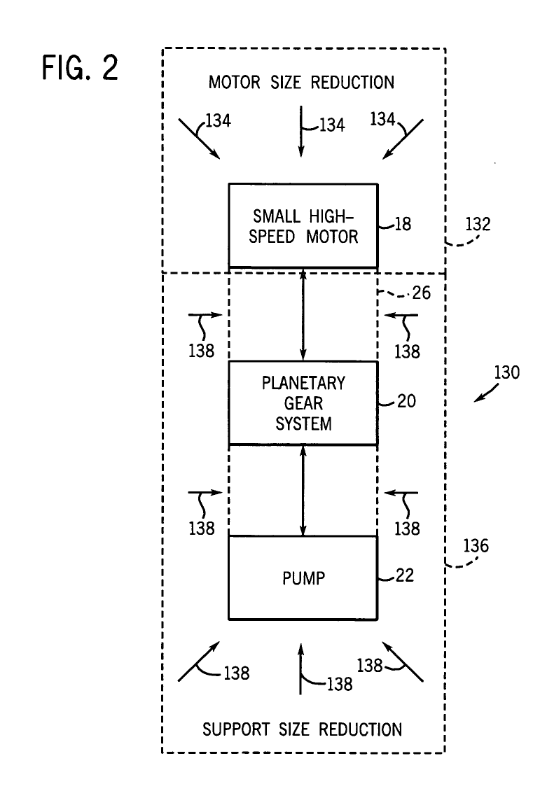

FIG. 2 is a block diagram of an exemplary embodiment of a modular pumping system 130 having the planetary gear system 20. In the illustrated embodiment, the planetary gear system 20 enables a substantial motor size reduction from a standard large direct drive motor 132 to a relatively small high speed motor 18 as illustrated by arrows 134. For example, the standard large direct drive motor 132 may have a speed output in the range of 400-600 RPM and a torque output of about 1×10⁶ inch-pounds. In contrast, the relatively small high speed motor 18 may have a speed output in the range of 1800-3600 RPM and a torque output of about 175×10³ inch-pounds. The smaller motor tends to be more efficient and also has a higher power factor. These features can significantly lower the life cycle operating costs.

As a result of the substantially reduced motor size, the planetary gear system 20 also enables a substantial support size reduction from a standard large direct driven support structure 136 to a relatively small support structure 26 as indicated by arrows 138. As appreciated in view of the foregoing examples, the motor 132 and the support structure 136 have significantly greater dimensions, weight, and overall size in a direct drive configuration without the intermediate planetary gear system 20. Thus, the planetary gear system 20 substantially reduces the costs, support structures, and general complexities of the larger direct drive configuration of the motor 132 and the support structure 136.

The planetary gear system 20 also simplifies the installation, access, handling, and general maintenance of the modular pumping system 130. For example, the reduced size as illustrated by the small high speed motor 18 and the small support structure 26 can allow additional mounting arrangements of the modular pumping system 130. By further example, the modular pumping system 130 may be mounted entirely above the water line or other body of liquid. The modular pumping system 130 also enables a variety of different small high speed motors 18, planetary gear systems 20, and pumps 22 to be selectively coupled together to meet the demands of a particular pumping application. For example, a particular application may have a shorter or longer horizontal run of fluid conduit, a larger or smaller head or vertical run of fluid conduit, a smaller or greater desired fluid flow rate, and so forth.

FIG. 3 is a block diagram of an exemplary embodiment of a modular drive system 140 having a family of interchangeable motors or motor modules 142 and different families of interchangeable transmission modules 144. For example, the family of interchangeable motors or motor modules 142 may include different sizes or motor parameters, such as speed, horse power, torque, variable speeds, and so forth. In addition, the different families of interchangeable transmission modules 144 may include a plurality of different motor-to-pump transmissions, which may include planetary gear assemblies, clutches, pump speed and/or thrust controllers, and combinations thereof. As illustrated, the different families of interchangeable transmission modules 144 may include a plurality or family of planetary gear modules 146, a plurality or family of control start transmission modules 148, and plurality or family of integral planetary gear and clutch modules 150, a plurality or family of planetary gear modules 152 respectively coupled to a plurality or family of clutch modules 154, and a plurality or family of clutch modules 156 respectively coupled to a plurality or family of planetary gear modules 158.

For example, as discussed in further detail below, each planetary gear module 146 may include a central sun gear, a plurality of planet gears disposed about the central or sun gear, and an outer ring gear disposed about the plurality of planet gears. The control start transmission module 148 may include one or more gear reduction mechanisms, one or more clutch mechanisms, and one or more feedback control mechanisms to enable variable speed output from the motor 142 in response to various feedback data. The integral planetary gear and clutch module 150 may include a planetary gear assembly, such as a central or sun gear, a plurality of surrounding planet gears, and a surrounding ring gear. In addition, the integral planetary gear and clutch module 150 may include a variety of clutch mechanisms, such as a wet clutch, disposed near an input or an output drive shaft. In other words, the clutch mechanism may be disposed before, after, or simultaneous with the gear reduction mechanisms in a common housing. The planetary gear modules 152 and clutch modules 154 are generally configured to engage the motor 142 with a shaft between the clutch module 154 and the motor 142. In contrast, each set of clutch module 156 and corresponding planetary gear module 158 is configured to engage a selected motor 142 with a shaft between the planetary gear module 158 and the motor 142.

In view of these different features, the modular drive system 140 as illustrated in FIG. 3 enables a variety of configurations between different motors 142 and different transmission modules 144. Again, the different motors 142 can have different operational characteristics, while each module 146, 148, 150, 152, 154, 156, and 158 in the different families of interchangeable transmission modules 144 can have different gear ratios, clutch features, and so forth. For example, the gear ratios in each family can include a series of incrementally increasing gear ratios from a base ratio to a max ratio. Similarly, each clutch in the different families can include a series or set of incrementally increasing ranges of clutch play and other operational ranges. Therefore, the different modules can be coupled together to suit a particular application or load, such as a pumping application, a conveyer belt application, and so forth.

FIG. 4 is a block diagram of an exemplary embodiment of a modular pump system 160 including the different families of interchangeable transmission modules 144 as illustrated and described above with reference to FIG. 3, further including a plurality or family of interchangeable pump or pump modules 162. Again, the different families of interchangeable transmission modules 144 may include a plurality or family or planetary gear modules 146, a plurality or family of control start transmission modules 148, a plurality or family of integral planetary gear and clutch modules 150, a plurality or family of planetary gear modules 152 respectively coupled with clutch modules 154, and a plurality or family of clutch modules 156 respectively coupled with planetary gear modules 158. Again, these different modules 144 may have a variety of different gear ratios, clutch ranges, and so forth. Similarly, the family of interchangeable pumps or pump modules 162 may have a series of pumps having incrementally changing pump features, such as pump speed, flow rate, output thrust, and so forth. As a result, the modular pump system 160 enables a wide range of different configurations of the transmission modules 144 and the pumps or pump modules 162 to meet the demands of a particular pumping application, such as a vertical pumping application.

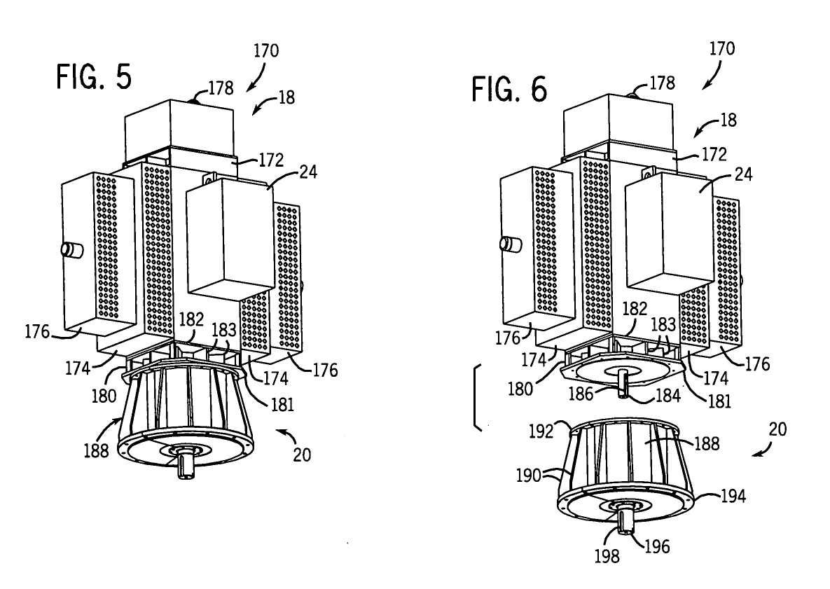

FIG. 5 is a perspective view of an exemplary vertical pump drive 170 having an embodiment of the motor 18 coupled to an embodiment of the planetary gear system 20 as discussed above with reference to FIGS. 1 and 2. In the illustrated embodiment, the motor 18 includes a central motor structure 172, opposite perforated venting portions 174 and 176, an embodiment of the control unit 24, an upper support structure 178, and a lower support structure 180. The lower support structure 180 may include a mount panel 181, an opposite panel 182, and intermediate ribs or support members 183. The illustrated planetary gear system 20 may include or embody an integral planetary gear and clutch module, such as mentioned above with reference to module 150 as illustrated in FIGS. 3 and 4. The integral planetary gear and clutch module 20 may be selectively mounted and dismounted with the motor 18 and one or more alternative motors to meet the demands of a particular load or application, such as a vertical and/or horizontal pumping application.

FIG. 6 is an exploded perspective view of the vertical pump drive 170 as illustrated in FIG. 5, further illustrating the integral planetary gear and clutch module 20 exploded from the motor 18. As illustrated in FIG. 6, the motor 18 includes a motor output shaft or drive shaft 184 extending outwardly from the mount panel 181. The motor output shaft or drive shaft 184 may include a variety of coupling mechanisms to engage with the integral planetary gear and clutch module 20. However, the illustrated drive shaft 184 includes a key slot 186. The integral planetary gear and clutch module 20 includes a casing or enclosure 188 having support ribs 190 extending lengthwise between a first flange or motor mount 192 and a second flange or pump mount 194. The integral planetary gear and clutch module 20 also includes an output shaft 196 extending outwardly from the central flange or pump mount 194. Similar to the drive shaft 184, the output shaft 196 may have a variety of different coupling mechanisms to connect with a pump, machine, or other load. However, the illustrated output shaft 196 includes a key slot 198.

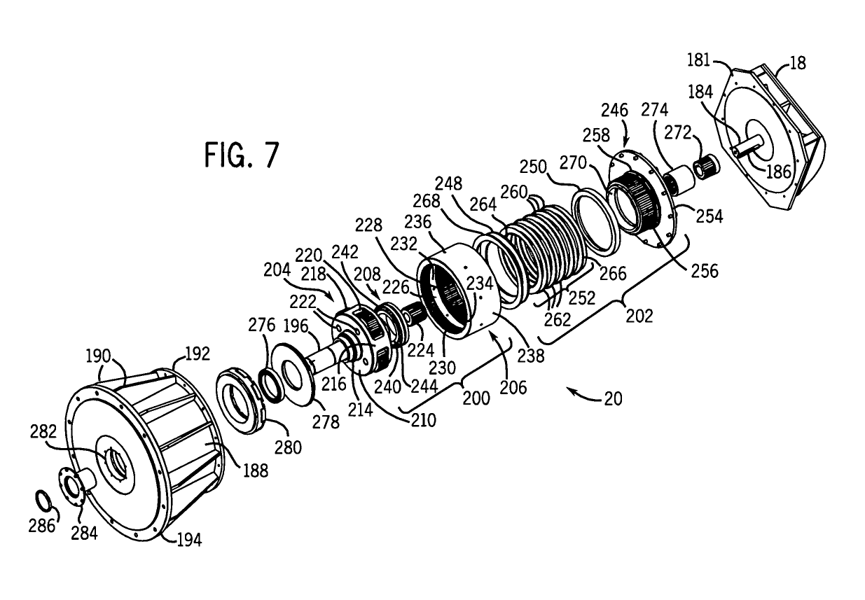

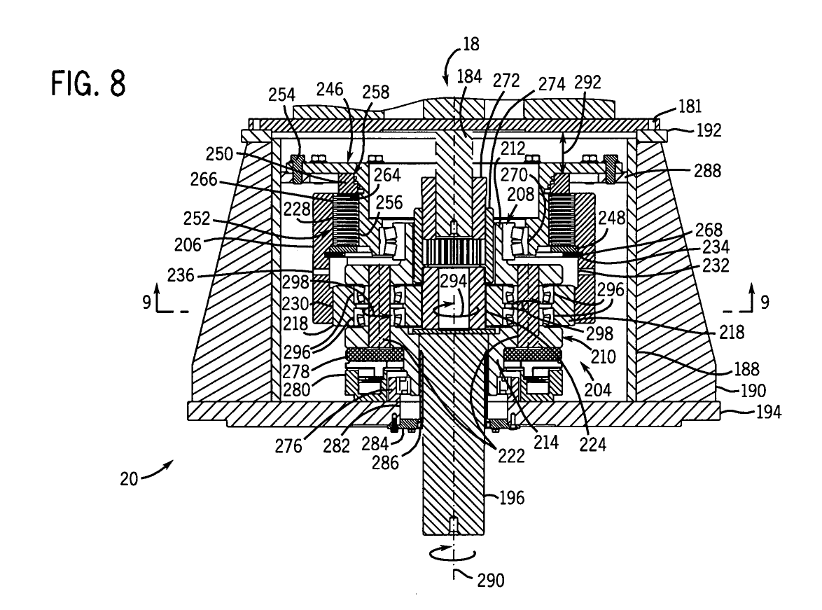

FIG. 7 is an exploded perspective view of an exemplary embodiment of the integral planetary gear and clutch module 20 as illustrated in FIGS. 5 and 6, further illustrating an embodiment of a gear system 200 and a clutch system 202. In the illustrated embodiment, the gear system 200 includes a planetary or epicyclic gear assembly 204, an outer ring gear 206, and a clutch-gear interface bearing 208 (e.g., a radial bearing). For example, the illustrated planetary gear assembly 204 includes a gear carrier 210 having a first annular portion or support structure 212, a second annular or support structure 214, and a third annular or intermediate support structure 216 disposed between the structures 212 and 214 (see FIGS. 7 and 8). In addition, the planetary gear assembly 204 includes a plurality of planet gears 218 disposed in planet gear receptacles or engagement openings 220 within the intermediate support structure 216 of the gear carrier 210. For example, the planetary gear assembly 204 may include a set of 3, 4, 5, 6, or more planet gears 218 and corresponding engagement openings 220. In addition, the planetary gear assembly 204 includes a planet shaft 222 for each respective planet gear 218 to rotate about within the engagement opening 220. The planetary gear assembly 204 also includes the output shaft 196 extending through the support structure 214 into the interior of the intermediate support structure 216 to a central or sun gear 224, which engages each of the planet gears 218 as illustrated and discussed below with reference to FIG. 8. The planetary gear assembly 204 extends partially into and mates with the ring gear 206.

As illustrated in FIG. 7, the ring gear 206 has a generally cylindrical interior 226 having first and second inner annular gear portions or inner teeth 228 and 230, which are generally offset from one another by an annular separation portion 232 having a ring slot 234. The ring gear 206 also may include a plurality of lubrication passages 236 extending from a generally cylindrical exterior 238 to the generally cylindrical interior 226. As discussed in further detail below, the planetary gear assembly 204 is inserted into the ring gear 206, such that each of the planet gears 218 engages the inner teeth 230. In addition, the bearing 208 may be disposed about the support structure 212 of the planetary gear assembly 204, such that the gear carrier 210 may rotatingly engage a portion of the clutch system 202. The illustrated bearing 208 includes inner and outer bearing sleeves 240 and 242 disposed concentrically about a plurality of roller members 244.

The illustrated clutch system 202 of FIG. 7 includes a first clutch support or annular engagement member 246 and a second clutch support or annular clutch pressure plate 248. In certain embodiments, the engagement member 246 may be described as a clutch carrier, and the clutch pressure plate 248 may be described as a clutch pack backing ring. The engagement member 246 and pressure plate 248 are disposed about an annular piston or clutch control mechanism 250 and a set of alternating inner and outer geared clutch plates 252. In certain embodiments, the set of clutch plates 252 may be described as a clutch pack. As illustrated, the engagement member 246 includes a disc portion 254 and an outer annular gear portion or outer teeth 256. In addition, the illustrated engagement member 246 includes a piston interface or seal portion 258 disposed in the region between the disc portion 254 and the outer teeth 256.

The illustrated set of alternating clutch plates 252 includes a first set of clutch plates 260 and a second set of clutch plates 262. The clutch plates 260 include inner teeth 264, while the clutch plates 262 include outer teeth 266. In assembly, these clutch plates 260 and 262 may be alternated one after the other, such that the inner and outer teeth 264 and 266 alternate in a corresponding manner.

The clutch system 202 also may include an annular retainer or clutch securement ring 268, which engages or generally interlocks with the ring slot 234 disposed within the ring gear 206. As discussed below, the clutch securement ring 268 secures the pressure plate 248 adjacent the inner teeth 228 inside the ring gear 206. In addition, the clutch plates 252 may be inserted into the ring gear 206, such that the clutch plates 262 having the outer teeth 262 engage with the inner teeth 228. Furthermore, the illustrated clutch control mechanism 250 may be assembled in movable engagement between the engagement member 246 and the clutch pressure plate 248.

As further illustrated in FIG. 7, when the clutch system 202 is assembled with the gear system 200, the outer teeth 256 extend into the set of alternating clutch plates 252 within the ring gear 206. In this configuration, the outer teeth 256 engage with the inner teeth 264 of the alternating clutch plates 260. Furthermore, the bearing 208 generally extends into the outer teeth 256, such that the outer bearing sleeve 242 fits within an inner cylindrical portion or bearing interface 270 of the engagement member 246. The bearing 208 also extends around the support structure 212 and engages the intermediate support structure 216 of the planetary gear assembly 204 when assembled within the ring gear 206.

In addition to these features of the gear system 200 and clutch system 202, the integral planetary gear and clutch module 20 may include a drive gear or outer annular gear 272 secured about or generally coupled with the shaft 184 of the motor 18. In addition, a drive gear coupling or inner annular gear 274 may be disposed about the gear 272 and a portion of the sun gear 224, as illustrated and described below with reference to FIG. 8. In certain embodiments, the gears 272 and 274 may be described as a spline hub and a spline coupling, respectively. Furthermore, the module 20 may include a plurality of annular support structures, seals, shock absorbent mechanisms, bearings, and so forth. For example, annular structures or assemblies 276, 278, and 280 may be disposed between the planetary gear assembly 204 and an inner portion of the enclosure 188. In certain embodiments, the assemblies 276, 278, and 280 include a radial bearing, a thrust plate, and a thrust bearing, respectively. As discussed in further detail below, the output shaft 196 of the planetary gear assembly 204 extends through a shaft opening 282 having a shaft flange 284 and an annular seal 286 disposed in the enclosure 188.

FIG. 8 is a cross-sectional view of the integral planetary gear and clutch module 20 as illustrated in FIG. 7, further illustrating the gear system 200 and the clutch system 202 integrally assembled within the enclosure 188. For example, as illustrated in FIG. 8, the engagement member 246 has the disc portion 254 disposed adjacent the ring gear 206, while the outer teeth 256 extend into the ring gear 206. Specifically, the outer teeth 256 are disposed concentrically within the inner teeth 228 of the ring gear 206. The alternating clutch plates 252 are disposed between the outer teeth 256 and the ring gear 206 in engagement with both the outer teeth 256 and the inner teeth 228. In addition, the clutch pressure plate 248 is secured by the ring 268 directly adjacent the clutch plates 252 within the ring gear 206.

Opposite from the plate 248, the clutch control mechanism 250 is disposed between the engagement member 246 and the clutch plates 252. In the illustrated embodiment, the engagement member 246 is generally secured within the enclosure 188 via one or more outer securement portions or mechanisms 288, while the ring gear 206 can selectively rotate or become fixed with respect to a central axis 290. More specifically, the clutch control mechanism 250 may be variably engaged or disengaged to move toward or away from the clutch plates 252, as indicated by arrow 292. For example, the seal portion 258 disposed on the engagement member 246 may include one or more ring seals and or fluid passages to increase or decrease fluid pressure against the clutch control mechanism 250. In this manner, the clutch control mechanism 250 can increase or decrease the pressure on the clutch plates 252 between the clutch control mechanism 250 and the clutch pressure plate 248.

As discussed above, the clutch plates 260 are generally geared or secured to the outer teeth 256 on the engagement member 246. However, the clutch plates 262 are generally geared or secured to the ring gear 206. If the pressure or force is relatively low between the clutch control mechanism 250 and the clutch pressure plate 248, then the clutch plates 260 and 262 can generally slide or rotate with respect to one another without any substantial torque transference. As appreciated, a quantity of cooling oil is pumped into the interior of the module 20, such that a film or amount of the oil resides between the alternating clutch plates 260 and 262. Torque is generally transmitted between the clutch plates 260 and 262 via shearing of the oil film separating the plates 260 and 262, thereby at least substantially reducing or eliminating wear on the facing surfaces of the plates 260 and 262. For this reason, the clutch may be described as a wet clutch. If the pressure or force is increased between the clutch control mechanism 250 and the clutch pressure plate 248, then the increasing shear in the oil film between the clutch plates 260 and 262 will gradually restrict and eventually prevent rotation between the clutch plates 260 and 262. As a result, full engagement of the clutch control mechanism 250 will gradually slow the rotation and fix the ring gear 206 within the enclosure 188. As a result of this gradual fixation of the ring gear 206, the planetary gear assembly 204 will gradually start and increase rotation about the central axis 290 within the ring gear 206.

Specifically, the illustrated planetary gear assembly 204 is rotatingly coupled to or geared with both the motor shaft 184 and the ring gear 206. For example, as discussed above, the sun gear 224 of the planetary gear assembly 204 may be coupled to the motor shaft 184 via the gear 272 and the gear 274. As illustrated in FIG. 8, the gear 274 extends partially around and is geared with both the gear 272 and the sun gear 224. Thus, as the motor shaft 184 rotates about the central axis 290, the sun gear 224 also rotates as indicated by arrow 294.

Again, as discussed above, each of the planet gears 218 is rotatingly coupled to or generally geared with the sun gear 224 as well as the inner teeth 230 of the ring gear 206. As illustrated, the planet gears 218 also include one or more bearing structures or assemblies 296 disposed along the planet shafts 222 between the support structures 212 and 214 of the gear carrier 210. Thus, as the sun gear 224 rotates as indicated by arrow 294, the planet gears 218 rotate about the respective planet shafts 222 as indicated by arrows 298.

In turn, the planet gears 218 force the ring gear 206 to rotate about the planetary gear assembly 204 or, alternatively or simultaneously, the planet gears 218 cause the planetary gear assembly 204 along with the output shaft 196 to rotate about the central axis 290. For example, if the output shaft 196 of the planetary gear assembly 204 is coupled to a load and the clutch control mechanism 250 is not sufficiently engaged to overcome the load, then the rotation of the planet gears 218 will generally cause the ring gear 206 to rotate about the central axis 290 without any corresponding rotation of the planetary gear assembly 204. However, as the clutch control mechanism 250 gradually increases the friction between the first and second sets of clutch plates 260 and 262, the ring gear 206 will gradually become fixed causing the planetary gear assembly 204 to rotate within the ring gear 206.

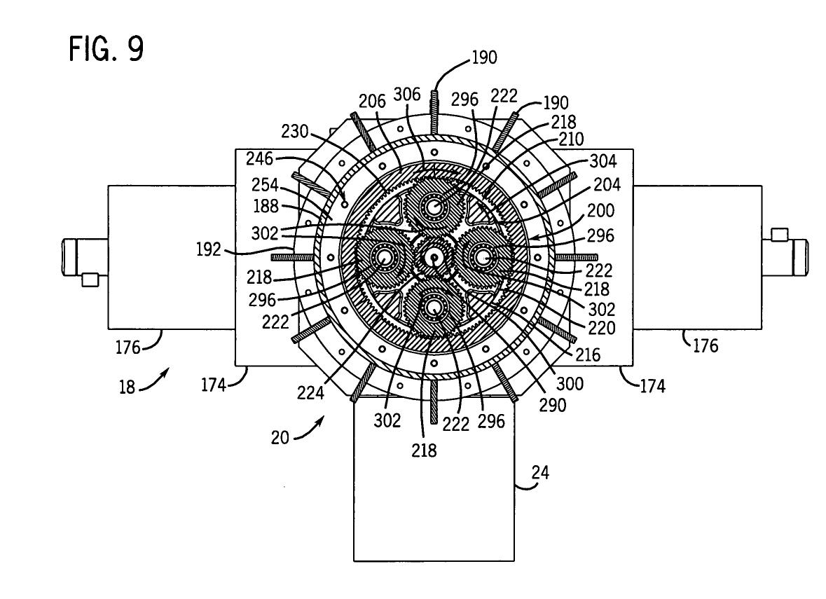

FIG. 9 is a cross-sectional view of an embodiment of the integral planetary gear and clutch module 20 as illustrated in FIGS. 5-8, further illustrating the interrelationship between the ring gear 206, a set of four planet gears 218, and the sun gear 224 of the gear system 200. In the illustrated embodiment, the motor 18 rotatingly drives the sun gear 224 in a first rotational direction (e.g., counter clockwise) as indicated by arrow 300. As discussed above with reference to FIG. 7, the shaft 184 of the motor 18 is coupled to the sun gear 224 by the gear 272 and the gear 274. The drive shaft 184 and the gears 272, 274, and 224 all rotate together about the same central axis 290 and, thus, generally have the same rate of angular rotation or rotational speed, e.g., rotations per minute (RPM). For purposes of discussion, the speed generally refers to rate of angular rotation or rotational speed, rather than the surface speed or tangential speed at the interface between engaging gears, shafts, or other rotating components.

Turning now to the gear system 200, the sun gear 224 drives three or more (e.g., four planet gears 218) in a second rotational direction (e.g., clockwise) as indicated by arrows 302. Thus, the four planet gears 218 rotate in an opposite rotational direction relative to the sun gear 224. In turn, the planet gears 218 engage the ring gear 206 to cause rotation of the gear carrier 210 as indicated by arrow 304, or to cause rotation of the ring gear 206 as indicated by arrow 306, or a combination thereof.

In other words, if the clutch system 202 is operated to completely fix the ring gear 206 within the integral planetary gear and clutch module 20, then the planet gears 218 generally impart all of the speed and torque to cause the gear carrier 210 to rotate in a third rotational direction (e.g., counterclockwise) within the stationary outer ring gear 206 as indicated by arrow 304. Alternatively, if the clutch system 202 is operated to allow complete or free rotation of the ring gear 206 and if a load is coupled to the output shaft 196, then the gear carrier 210 of the planetary gear assembly 204 may remain at least substantially or entirely stationary within the ring gear 206. In this scenario, the planet gears 218 may impart a substantial portion or all of the speed and torque to the ring gear 206 to cause rotation of the ring gear 206 in a fourth rotational direction (e.g., clockwise) as indicated by arrow 306. However, if the clutch system 202 is partially engaged and if the load is coupled to the output shaft 196, then the planet gears 218 may engage with the ring gear 206 to cause some counterclockwise rotation of the gear carrier 210 and some clockwise rotation of the ring gear 206 as indicated by arrows 304 and 306. In other words, operation of the clutch system 202 can gradually slow or stop the clockwise rotation of the ring gear 206, while simultaneously ramping up or increasing the counterclockwise rotation of the gear carrier 210 and the corresponding output shaft 196.

In the illustrated embodiment, the planet gears 218 have a radius or diameter substantially larger than the radius or diameter of the sun gear 224, while the ring gear 206 has a radius or diameter substantially larger than radius or diameter of the planet gears 218 and the sun gear 224. In general, the gear ratio depends on the sun gear 224 and the ring gear 206 in the illustrated embodiment. Specifically, the gear ratio may be calculated as:

Gear Ratio=(Teeth in Ring Gear)/(Teeth in Sun Gear)+1

As a result, the gear ratio generally increases as the diameter and number of teeth in the ring gear 206 increases relative to the sun gear 224. In certain embodiments, the gear ratio may be in the range of about 3:1 to about 9:1, or in the range of about 4.5:1 to about 5:1. Accordingly, the gear system 200 can substantially reduce the speed and substantially increase the torque of the motor 18, while the clutch system 202 can gradually or progressively impart the rotation of the motor output shaft or drive shaft 184 to the output shaft 196 of the integral planetary gear and clutch module 20. For example, the gear system 200 may reduce the output speed of the motor 18 from about 1800-3600 RPM to about 200-1000 RPM (or about 200-800 RPM) at the pump 22. The gear system 200 also may increase the torque to between about 10,000 inch-pounds and 2,000,000 inch-pounds at the pump 22.

In certain embodiments, the module 20 as illustrated in FIG. 9 may represent a planetary gear system 200 without a corresponding clutch system 202 as illustrated in FIG. 7. In other words, the ring gear 206 may be fixably disposed within the enclosure 188 of the module 20, rather than selectively rotating or becoming stationary in response to the clutch system 202 as illustrated in FIG. 7. In this alternative embodiment, the motor output shaft or drive shaft 184 causes rotation of the sun gear 224 as indicated by arrow 300, which in turn causes rotation of the planet gears 218 as indicated by arrow 302. However, rather than allowing any selective movement of the ring gear 206, the planet gears 218 rotate along the inner teeth 230 of the ring gear 206 to cause rotation of the gear carrier 210 as indicated by arrow 304. Again, the ring gear 206 is stationary in this alternative embodiment, such that all of the speed and torque is transmitted to the gear carrier 210 rather than the ring gear 206.

Thus, the module 20 may include or exclude the clutch system 202 in various embodiments. Furthermore, other embodiments of the module 20 may include other forms or types of clutch systems, other arrangements or gear ratios of the planetary gear assembly 204, and so forth. Again, the module 20 substantially increases torque and decreases speed of the motor 18. As a result, each of these embodiments enables the use of a substantially smaller motor 18 and a substantially smaller support structure 26, thereby reducing costs and complexities associated with pumping a large body of water to a remote site as discussed above.

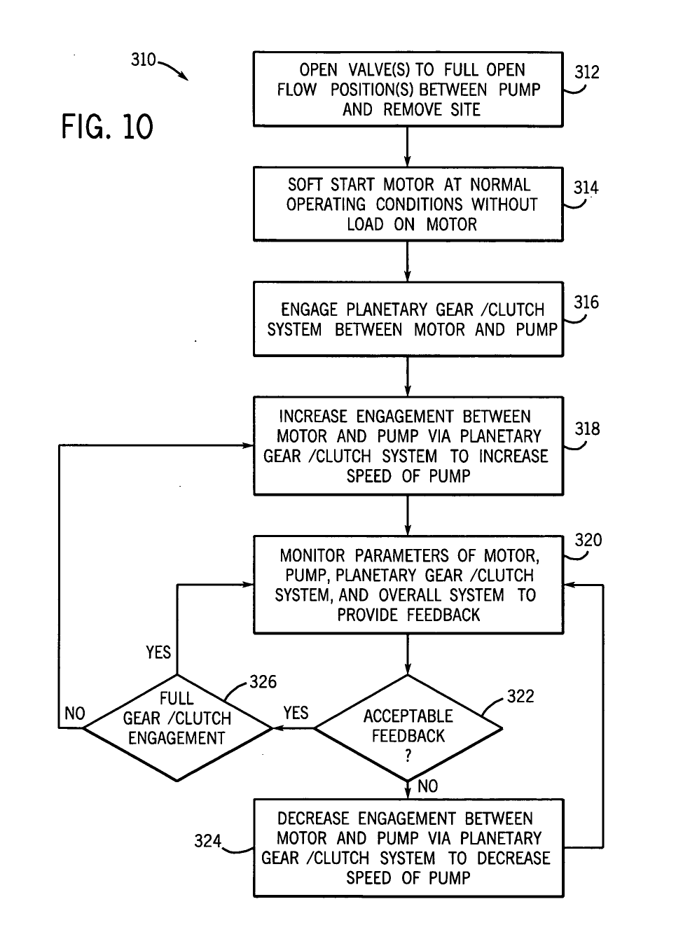

FIG. 10 is a flow chart of an exemplary embodiment of a pumping process 310 using an embodiment of the planetary gear system 20 as discussed in detail above. As illustrated, the process 310 includes opening one or more valves to full open flow positions at or between a pump and a remote site (block 312). The process 310 also includes soft starting the motor at normal operating conditions without a load on the motor (block 314). For example, the soft start process 314 may involve starting up the motor with a clutch at least partially or completely disconnected from the load, e.g., a pump disposed within a liquid. At block 316, the process 310 further includes engaging a planetary gear/clutch system between the motor and the pump. For example, the engagement process 316 may involve an initial engagement of clutch plates, such as wet clutch plates, between the motor and the pump. The process 310 may then proceed by increasing engagement between the motor and the pump via the planetary gear/clutch system to increase the speed of the pump (block 318). For example, the process 310 may slowly compress the clutch plates together, thereby causing friction and torque to cause a gradual increase in the rotation of the planetary gear assembly between the motor and the pump.

At block 320, the process 310 may include monitoring one or more parameters of the motor, the pump, the planetary gear/clutch system, and the overall system to provide feedback for controlling the operation of the planetary gear/clutch system. At block 322, the process 310 may query whether or not the feedback is acceptable. If the process 310 identifies the feedback 322 as unacceptable, then the process 310 may respond by decreasing engagement between the motor and the pump via the planetary gear/clutch system to decrease the speed of the pump (block 324). In turn, the process 310 loops back or continues by monitoring parameters of the motor, the pump, the planetary gear/clutch system, and the overall system to provide feedback (block 320).

If the process 310 identifies the feedback as acceptable at block 322, then the process 310 may proceed to query whether or not the planetary gear/clutch system is in full engagement between the motor and the pump (block 326). If the process 310 determines that the planetary gear/clutch system is in full engagement at block 326, then the process 310 may continue or loop back to monitor parameters of the motor, the pump, the planetary gear/clutch system, and the overall system to provide feedback (block 320). Otherwise, if the process 310 determines that the planetary gear/clutch system is not fully engaged between the motor and the pump at block 326, then the process 310 may loop back or continue by increasing engagement between the motor and the pump via the planetary gear/clutch system to increase the speed of the pump (block 318). Again, the process 310 continues to loop through blocks 320, 322, 324, and 326. In this manner, the pumping process 310 operates in a closed loop to gradually increase or decrease the speed of the pump using the planetary gear/clutch system and feedback obtained throughout the pumping system. The illustrated process 310 may be applied to a start up procedure, a shut down procedure, a transient hydraulic instability condition, and so forth. By using the process 310, the pump can gradually increase or decrease to the desired operating speed with a substantially reduced possibility of water hammer or other damaging hydraulic effects.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A pump system, comprising:
a variable output transmission, comprising:
a rotatable motor coupling;
a rotatable pump coupling;
a planetary gear assembly disposed between the rotatable motor coupling and the rotatable pump coupling; and
a clutch disposed between the rotatable motor coupling and the rotatable pump coupling; and
a controller configured to control the clutch in response to fluid pumping feedback.

2. The pump system of claim 1, wherein the controller is configured to adjust slip of the clutch to adjust speed of the rotatable pump coupling in response to a pump thrust load.

3. The pump system of claim 1, wherein the controller is configured to vary engagement of the clutch relative to the planetary gear assembly to soft start the rotatable pump coupling.

4. The pump system of claim 1, wherein the controller is configured to vary engagement of the clutch relative to the planetary gear assembly to control speed of the rotatable pump coupling.

5. The pump system of claim 1, wherein the fluid pumping feedback comprises pump speed, pump thrust, fluid flow rate, fluid pressure, or a combination thereof relating to the pump system.

6. The pump system of claim 1, wherein the fluid pumping feedback comprises motor feedback, pump feedback, transmission feedback, or a combination thereof relating to the pump system.

7. The pump system of claim 1, wherein planetary gear assembly comprises a sun gear, a plurality of planet gears disposed about and engaged with the sun gear, and a ring gear disposed about and engaged with the plurality of planet gears.

8. The pump system of claim 7, wherein the clutch is engageable to change the ring gear between rotatable and fixed conditions.

9. The pump system of claim 1, wherein the pump system is configured to be at least partially submerged, or the pump system is configured to pump fluid at least partially along a generally vertical path, or a combination thereof.

9. The pump system of claim 1, comprising a motor coupled to the rotatable motor coupling, a pump coupled to the rotatable pump coupling, or a combination thereof.

10. A method, comprising:
reducing speed and increasing torque from a motor to a pump via a planetary gear assembly; and
controlling a clutch to vary engagement of the planetary gear assembly between the motor and the pump in response to feedback relating to the pump.

11. The method of claim 10, wherein controlling the clutch comprises receiving the feedback indicative of a hydraulic load on the pump.

12. The method of claim 10, wherein controlling the clutch comprises varying engagement of the clutch relative to the planetary gear assembly to soft start the pump.

13. The method of claim 10, wherein controlling the clutch comprises varying engagement of the clutch relative to the planetary gear assembly to control speed of the pump.

14. The method of claim 10, wherein reducing speed and increasing torque comprises gearing the motor to the pump with a gear ratio of between about 3:1 to about 9:1.

15. The method of claim 10, comprising receiving a rotational speed of the motor in a range of about 1800 to 3600 RPM.

16. The method of claim 10, wherein reducing speed and increasing torque comprises rotating a plurality of planet gears disposed between and engaged with both a sun gear and an outer ring gear.

17. The method of claim 16, wherein controlling the clutch comprises adjusting the outer ring gear between fixed and rotatable conditions.

18. A method, comprising:
providing a motor-to-pump transmission having a planetary gear assembly and a clutch, wherein the clutch is engageable to vary output speed to a pump in response to a hydraulic load on the pump.

19. The method of claim 18, comprising providing a controller to receive feedback relating to the hydraulic load and to control the clutch based on the feedback.

20. The method of claim 18, comprising providing a pump to couple with the motor-to-pump transmission.
